(19) United States
(12) Patent Application Publication
(10) Pub. No.: US 2025/0303755 A1
(43) Pub. Date: Oct. 2, 2025

(54) RECORDING APPARATUS, CONTROL METHOD OF RECORDING APPARATUS, AND MEDIUM

(71) Applicant: BROTHER KOGYO KABUSHIKI KAISHA, Nagoya (JP)

(72) Inventors: Isao KOBAYASHI, Nagoya (JP); Yusuke ARAI, Nagoya (JP); Hiroaki TAKAHASHI, Nagoya (JP)

(73) Assignee: BROTHER KOGYO KABUSHIKI KAISHA, Nagoya (JP)

(21) Appl. No.: 19/083,183

(22) Filed: Mar. 18, 2025

(30) Foreign Application Priority Data
Mar. 28, 2024 (JP) 2024-054941

(51) Int. Cl. B41J 11/70; B41J 11/00

(52) U.S. Cl. CPC B41J 11/70; B41J 11/008

(57) ABSTRACT

There is provided a recording apparatus including: a recorder; a cutter; a conveyor; and a controller. A cutting position is located upstream of the recorder in a conveyance route. The controller is configured to execute first control to generate first and second recorded items. The first control includes: a first conveying process of causing the conveyor to convey a recording medium; a first recording process of causing the recorder to record at least a part of a first image on the recording medium; a second conveying process of causing the conveyor to convey the recording medium so that a cutting planned position of the recording medium is located at the cutting position; a first cutting process of causing the cutter to cut the recording medium; and a second recording process of causing the recorder to record a second image on the second medium obtained by cutting the recording medium.

### REFERENCE TO RELATED APPLICATIONS

This application claims priority from Japanese Patent Application No. 2024-054941 filed on Mar. 28, 2024. The entire content of the priority application is incorporated herein by reference.

### BACKGROUND ART

A configuration is known wherein a cutter (cutting part) is disposed downstream of a paper feed cassette in a conveyance route, in a paper feed part configured to feed a sheet to an image forming apparatus (recording apparatus). The sheet, which is taken out from the paper feed cassette, is cut and divided by the cutter. A recording part of the image forming apparatus records an image on the divided sheet.

### SUMMARY

In the above-described configuration, the distance from the recording part to the cutter (cutting part) is great. A space corresponding to the distance is required to be defined in the apparatus, which causes the apparatus to become large-sized.

An object of the present disclosure is to provide a recording apparatus, a control method of a recording apparatus, and a medium each suitable for reducing increase in a size of an apparatus having a configuration with a recording part and a cutting part.

According to a first aspect of the present disclosure, there is provided a recording apparatus including:
a recorder configured to record an image on a recording medium;
a cutter configured to cut the recording medium at a cutting position so as to divide the recording medium into a first medium and a second medium;
a conveyor configured to convey the recording medium toward the recorder along a conveyance route; and
a controller, wherein:

the cutting position is located upstream of the recorder in the conveyance route;
the controller is configured to execute first control so as to generate a first recorded item being the first medium on which a first image is recorded and a second recorded item being the second medium on which a second image is recorded; and
the first control includes:
   a first conveying process of causing the conveyor to convey a first objective recording medium to a recording start position, the first objective recording medium being the recording medium which is single and which is an object of the first control;
   a first recording process of causing the recorder to record at least a part of the first image on the first objective recording medium after the first conveying process;
   a second conveying process of causing the conveyor to convey the first objective recording medium so that a cutting planned position of the first objective recording medium is located at the cutting position after the first recording process;
   a first cutting process of causing the cutter to cut the first objective recording medium after the second conveying process; and
   a second recording process of causing the recorder to record the second image on the second medium obtained by cutting the first objective recording medium, after the first cutting process.

According to a second aspect of the present disclosure, there is provided a control method of a recording apparatus, the recording apparatus including:
a recorder configured to record an image on a recording medium;
a cutter configured to cut the recording medium at a cutting position so as to divide the recording medium into a first medium and a second medium; and
a conveyor configured to convey the recording medium toward the recorder along a conveyance route,
wherein the cutting position is located upstream of the recorder in the conveyance route,
the control method including executing first control so as to generate a first recorded item being the first medium on which a first image is recorded and a second recorded item being the second medium on which a second image is recorded,
wherein the first control includes:
   a first conveying process of causing the conveyor to convey a first objective recording medium to a recording start position, the first objective recording medium being the recording medium which is single and which is an object of the first control;
   a first recording process of causing the recorder to record at least a part of the first image on the first objective recording medium after the first conveying process;
   a second conveying process of causing the conveyor to convey the first objective recording medium so that a cutting planned position of the first objective recording medium is located at the cutting position after the first recording process;
   a first cutting process of causing the cutter to cut the first objective recording medium after the second conveying process; and
   a second recording process of causing the recorder to record the second image on the second medium obtained by cutting the first objective recording medium, after the first cutting process.

According to a third aspect of the present disclosure, there is provided a non-transitory and computer-readable medium storing a program executable by a controller of a recording apparatus, the recording apparatus including:
a recorder configured to record an image on a recording medium;
a cutter configured to cut the recording medium at a cutting position so as to divide the recording medium into a first medium and a second medium;
a conveyor configured to convey the recording medium toward the recorder along a conveyance route; and
the controller,
wherein the cutting position is located upstream of the recorder in the conveyance route,
the program is configured to cause the controller to execute first control so as to generate a first recorded item being the first medium on which a first image is recorded and a second recorded item being the second medium on which a second image is recorded,
wherein the first control includes:
   a first conveying process of causing the conveyor to convey a first objective recording medium to a recording start position, the first objective recording medium being the recording medium which is single and which is an object of the first control;
   a first recording process of causing the recorder to record at least a part of the first image on the first objective recording medium after the first conveying process;
   a second conveying process of causing the conveyor to convey the first objective recording medium so that a cutting planned position of the first objective recording medium is located at the cutting position after the first recording process;
   a first cutting process of causing the cutter to cut the first objective recording medium after the second conveying process; and
   a second recording process of causing the recorder to record the second image on the second medium obtained by cutting the first objective recording medium, after the first cutting process.

According to the present disclosure, the cutting position is located upstream of the recorder in the conveyance route. In this configuration, the cutting process is performed in the first control before recording the second image and after recording at least a part of the first image. Accordingly, even if a distance from the recorder to the cutting position is decreased, a conveyance distance of the recording medium for cutting the recording medium is less likely to increase, and efficiency in image recording is less likely to decrease. Thus, increase in a size of the recording apparatus can be reduced suitably.

### BRIEF DESCRIPTION OF DRAWINGS

FIG. 1 is a perspective view of a printer.

FIG. 2 is a vertical cross-sectional view of an internal structure of the printer of FIG. 1.

FIG. 3 is a block diagram of an electric configuration of the printer of FIG. 1.

FIG. 4 is a flow chart of a program executed by CPU of the printer depicted of FIG. 1.

FIG. 5A is a schematic view of step S32 depicted in FIG. 4. FIG. 5B is a schematic view of step S33 depicted in FIG. 4. FIG. 5C is a schematic view of step S34 depicted in FIG. 4. FIG. 5D is a schematic view of step S35 depicted in FIG. 4. FIG. 5E is a schematic view of step S36 depicted in FIG. 4.

FIG. 6A is a schematic view of step S41 depicted in FIG. 4. FIG. 6B is a schematic view of step S42 depicted in FIG. 4. FIG. 6C is a schematic view of step S43 depicted in FIG. 4. FIG. 6D is a schematic view of step S44 depicted in FIG. 4.

FIG. 7 is a flow chart of a program executed by CPU of a printer.

FIG. 8A is a schematic view of step S32 depicted in FIG. 7. FIG. 8B is a schematic view of step S33 depicted in FIG. 7. FIG. 8C is a schematic view of step S34 depicted in FIG. 7. FIG. 8D is a schematic view of step S36 depicted in FIG. 7.

FIG. 9 is a flow chart of a program executed by CPU of a printer.

FIG. 10A is a schematic view of a first scanning process executed in step S32 depicted in FIG. 9. FIG. 10B is a schematic view of a second scanning process executed in step S32 depicted in FIG. 9. FIG. 10C is a schematic view of step S33 depicted in FIG. 9. FIG. 10D is a schematic view of step S34 depicted in FIG. 9. FIG. 10E is a schematic view of step S36 depicted in FIG. 9.

FIG. 11 is a flow chart of a program executed by CPU of a printer.

FIG. 12A is a schematic view of step S32 depicted in FIG. 11. FIG. 12B is a schematic view of step S33 depicted in FIG. 11. FIG. 12C is a schematic view of step S36 depicted in FIG. 11. FIG. 12D is a schematic view of step S34 depicted in FIG. 11.

FIG. 13 is a flow chart of a program executed by CPU of a printer.

FIG. 14A is a schematic view of a first scanning process executed in step S132 depicted in FIG. 13. FIG. 14B is a schematic view of a second scanning process executed in step S132 depicted in FIG. 13. FIG. 14C is a schematic view of step S33 depicted in FIG. 13. FIG. 14D is a schematic view of step S34 depicted in FIG. 13.

### DESCRIPTION

### Embodiments

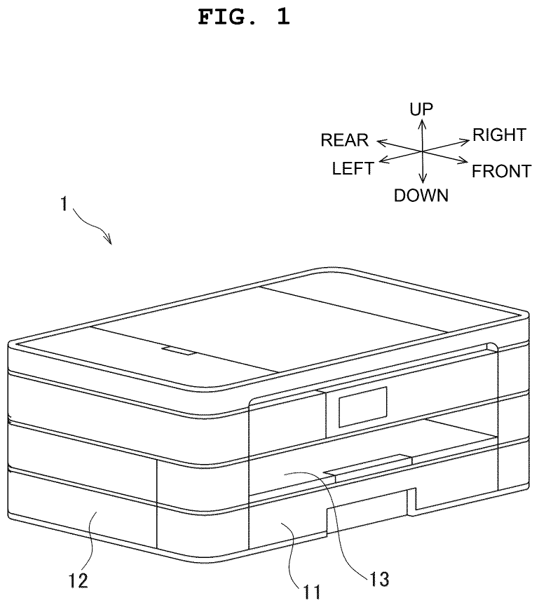

A printer 1 depicted in FIG. 1 is a first embodiment of a “recording apparatus” according to the present disclosure. In the following description, the respective directions of the printer 1 which are an up-down direction, a left-right direction and a front-rear direction are defined based on a state of FIG. 1 in which the printer 1 is disposed to be usable.

As depicted in FIG. 1, the printer 1 has a casing 12 which has a shape of a substantially rectangular parallelepiped, a sheet feed tray 11 which is disposed at a lower portion in the casing 12, and a sheet discharge tray 13 which is disposed above the sheet feed tray 11 in the casing 12.

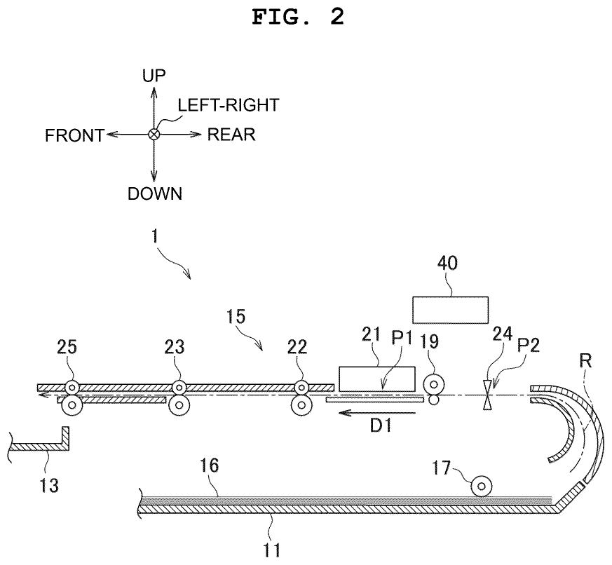

The sheet feed tray 11 is attachable and detachable with respect to the casing 12. As depicted in FIG. 2, the sheet feed tray 11 can accommodate a plurality of sheets 16, and can accommodate sheets 16 having a plurality of sizes. The plurality of sizes includes A4 size and A5 size, and lengths in the front-rear direction of the sheets 16 in a case where the sheets 16 having different sizes are placed in the sheet feed tray 11 are mutually different. The sheet 16 is an example of a “recording medium” of the present disclosure. The sheet feed tray 11 is an example of a “container” of the present disclosure.

The printer 1 has a recording unit 21, a cutting unit 24, a conveying unit 15, and a control unit 40 in the casing 12.

The recording unit 21 is based on the ink-jet system, and the recording unit 21 includes an ink channel having a plurality of nozzles and a driver IC. The plurality of nozzles is open in the lower surface of the recording unit 21. In a case where the driver IC is driven under the control of the control unit 40, the pressure is applied to the ink channel, and ink droplets of an ink are ejected from the nozzles. Accordingly, the ink droplets land on the sheet 16 located at a recording position P1, and an image is recorded on the sheet 16. The recording position P1 is located below the recording unit 21. The recording unit 21 is based on the serial system, and the recording unit 21 is supported by the casing 12 movably in the left-right direction.

The cutting unit 24 has a cutting blade and a cutting motor. The cutting blade includes a fixed blade and a rotary blade. In a case where the cutting motor is driven under the control performed by the control unit 40, the rotary blade is moved in the left-right direction while being rotated. Accordingly, the sheet 16 is cut at a cutting position P2, and the sheet 16 is divided into a first half part and a second half part. The cutting position P2 is a position at which the rotary blade is moved in the left-right direction in a state that the rotary blade is in contact with the fixed blade.

The conveying unit 15 conveys the sheet 16 toward the recording unit 21 along a conveyance route R. The conveyance route R spans from the sheet feed tray 11, passes through the cutting position P2 and the recording position P1, and arrives at the sheet discharge tray 13. In a case where the sheet 16 passes through the recording position P1, the sheet 16 is conveyed in the first direction D1 (frontward).

The cutting position P2 is located upstream of the recording unit 21 in the conveyance route R. A distance from the recording unit 21 to the cutting position P2 in the conveyance route R is smaller than a half of a length along the conveyance route R of a sheet 16 having a length along the conveyance route R which is greatest among the plurality of sizes of the sheets 16 accommodatable in the sheet feed tray 11. For example, the distance is 182 mm or less. Note that, the distance from the recording unit 21 to the cutting position P2 may be, for example, a distance along the conveyance route R from a position of a nozzle, among the plurality of nozzles of the recording unit 21, disposed upstream-most in the first direction D1 to the cutting position P2.

The conveying unit 15 includes a sheet feeding roller 17, conveying roller pairs 19, 22, 23 and 25, and a conveying motor. The sheet feeding roller 17 and the conveying roller pairs 19, 22, 23 and 25 are rotated by the driving of the conveying motor.

The sheet feed roller 17 is disposed so as to contact the surface of an uppermost sheet 16 among the plurality of sheets 16 accommodated in the sheet feed tray 11.

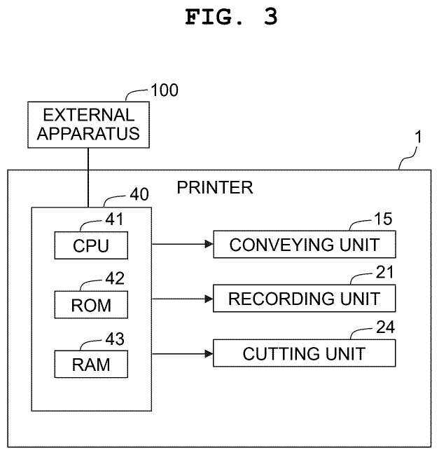

As depicted in FIG. 3, the control unit 40 includes a CPU 41, a ROM 42, and a RAM 43. The CPU 41 is an example of a “controller”. The ROM 42 stores a program and/or data with which the CPU 41 performs various kinds of control. The RAM 43 temporarily stores data to be used in a case where the CPU 41 executes the program.

The control unit 40 is electrically connected to the conveying unit 15, the recording unit 21, and the cutting unit 24. Further, the control unit 40 is electrically connected to an external apparatus (personal computer or the like) 100.

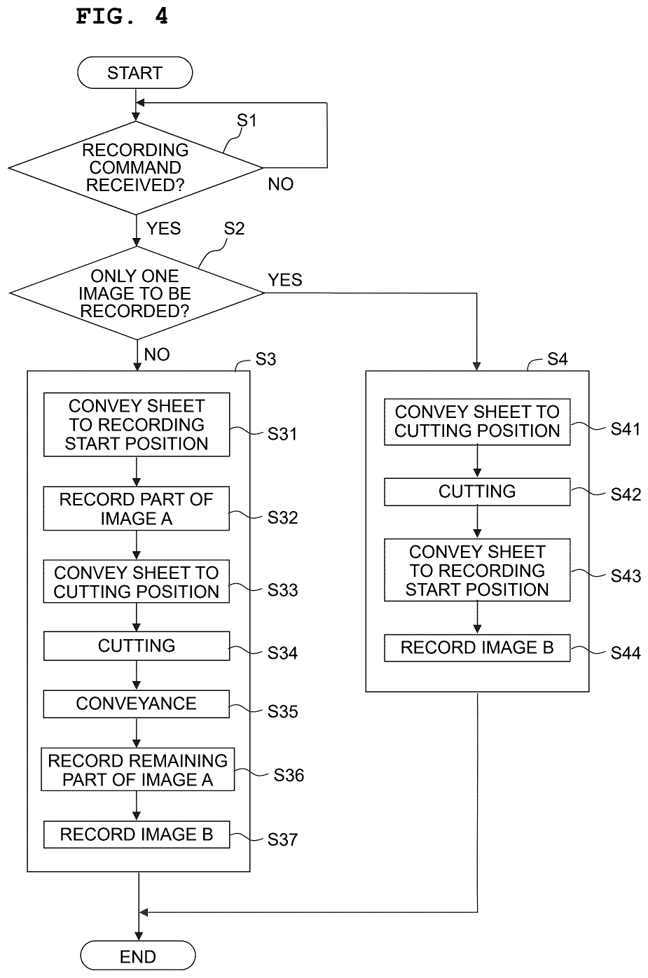

Next, the program executed by the CPU 41 will be described with reference to FIG. 4.

At first, the CPU 41 determines whether a recording command has been received from the external apparatus 100 (step S1). In a case where the CPU 41 determines that the recording command has not been received from the external apparatus 100 (step S1: NO), the CPU 41 repeats the process of step S1.

In a case where the CPU 41 determines that the recording command has been received from the external apparatus 100 (step S1: YES), the CPU 41 determines whether the recording command indicates recording of only one image (step S2).

In a case where the CPU 41 determines that the recording command does not indicate the recording of only one image (i.e., indicates recording of two images) (step S2: NO), the CPU 41 executes the control of step S3, and then the CPU 41 ends the program.

In a case where the CPU 41 determines that the recording command indicates the recording of only one image (step S2: YES), the CPU 41 executes the control of step S4, and then the CPU 41 ends the program.

Next, the control of each of step S3 and step S4 will be described.

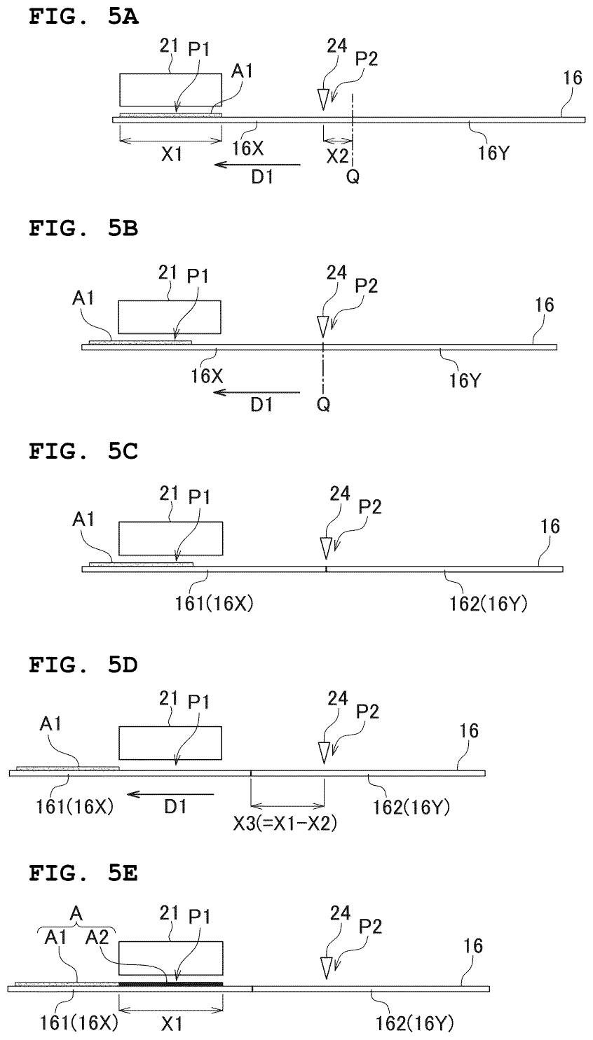

As depicted in FIG. 5E, the control of step S3 is a control for generating a first sheet piece 161 being the first half part 16X, of the sheet 16, on which an image A is recorded and a second sheet piece 162 being the second half part 16Y, of the sheet 16, on which an image B (not depicted) is recorded. The control of step S3 is an example of “first control”. The first half part 16X is a part which is located downstream in the first direction D1 in the sheet 16. The second half part 16Y is a part which is located upstream in the first direction D1 in the sheet 16. The first half part 16X is an example of a “first medium”, and the second half part 16Y is an example of a “second medium”. The first sheet piece 161 is an example of a “first recorded item”, and the second sheet piece 162 is an example of a “second recorded item”. The image A is an example of a “first image”, and the image B is an example of a “second image”.

In step S3, the CPU 41 firstly causes the conveying unit 15 to convey one sheet 16 accommodated in the sheet feed tray 11 to a recording start position (step S31: first conveying process). In this procedure, the first half part 16X is located at the recording position P1.

After step S31, as depicted in FIG. 5A, the CPU 41 causes the recording unit 21 to record a partial image A1, which is a part of the image A, on the first half part 16X of the sheet 16 (step S32: first recording process).

The process of step S32 includes: a scanning process of causing the recording unit 21 to eject the ink droplets from the nozzles while causing the recording unit 21 to move in the left-right direction with respect to the sheet 16 which stands still in the conveyance route R to thereby record an image; a conveying process of causing the conveying unit 15 to convey the sheet 16 by a distance X1 (see FIG. 5A) after the scanning process; and another scanning process of causing the recording unit 21 to eject the ink droplets from the nozzles while causing the recording unit 21 to move in the left-right direction with respect to the sheet 16 which stands still to thereby record an image after causing the conveying unit 15 to convey the sheet 16 by the distance X1 in the conveying process. The scanning process is an example of a “first process”, the conveying process is an example of a “second process”, and the another scanning process is an example of a “third process”. The distance X1 is an example of a “first distance”. In step S32, the scanning process and the conveying process are alternately performed. The process of step S32 includes the conveying process which is performed once or more and the scanning process which is performed twice or more.

After step S32, as depicted in FIG. 5B, the CPU 41 causes the conveying unit 15 to convey the sheet 16 in the first direction D1 so that a cutting planned position Q of the sheet 16 is located at the cutting position P2 (step S33: second conveying process). The cutting planned position Q is a position along the width direction (left-right direction) of a sheet 16 which passes the center in the first direction D1 of the sheet 16. As depicted in FIG. 5A, the cutting planned position Q is located upstream of the cutting position P2 in the first direction D1, by a distance X2, at the point in time at which the process of step S32 (first recording process) is completed. Accordingly, in step S33, the CPU 41 causes the conveying unit 15 to convey the sheet 16 in the first direction D1 by the distance X2. The distance X2 is an example of a “second distance”, and the distance X2 is smaller than the distance X1.

After step S33, as depicted in FIG. 5C, the CPU 41 causes the cutting unit 24 to cut the sheet 16 (step S34: first cutting process). Accordingly, the first half part 16X and the second half part 16Y are separated from each other.

After step S34, as depicted in FIG. 5D, the CPU 41 causes the conveying unit 15 to convey the first half part 16X and the second half part 16Y by a distance X3 in the first direction D1 (step S35: third conveying process). The distance X3 has a value obtained by subtracting the distance X2 from the distance X1. The distance X3 is smaller than the distance X1. The distance X3 is an example of a “third distance”.

After step S35, as depicted in FIG. 5E, the CPU 41 causes the recording unit 21 to record a partial image A2, which is the remaining part of the image A, on the first half part 16X (step S36: third recording process). Also in step S36, the scanning process and the conveying process are alternately performed like step S32.

After step S36, the CPU 41 causes the recording unit 21 to record the image B on the second half part 16Y (step S37: second recording process). Also in step S37, the scanning process and the conveying process are alternately performed like step S32. Accordingly, the first sheet piece 161 being the first half part 16X on which the image A is recorded and the second sheet piece 162 being the second half part 16Y on which the image B is recorded are generated.

After step S37, the first sheet piece 161 and the second sheet piece 162 are conveyed in the first direction D1 by the conveying unit 15, and the first sheet piece 161 and the second sheet piece 162 are received by the sheet discharge tray 13 (see FIG. 2).

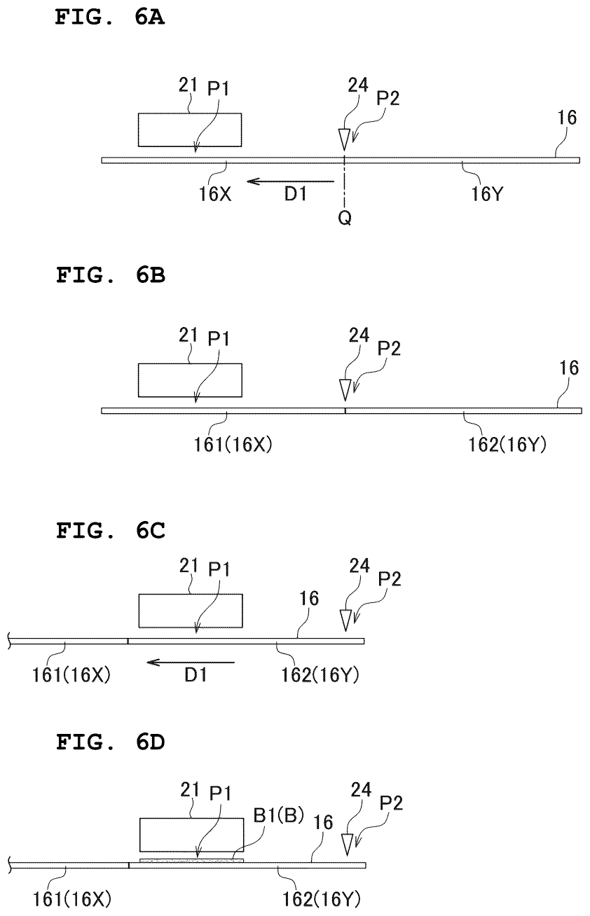

As depicted in FIG. 6D, the control of step S4 is a control for generating a first sheet piece 161 being the first half part 16X on which no image is recorded and a second sheet piece 162 being the second half part 16Y on which the image B is recorded. In this control, the image B is an example of a “third image”, and the second sheet piece 162 is an example of a “third recorded item”. The control of step S4 is the control which is different from the control of step S3 (first control). The control of step S4 is an example of “second control”.

In step S4, as depicted in FIG. 6A, the CPU 41 firstly causes the conveying unit 15 to convey the sheet 16 in the first direction D1 so that the cutting planned position Q of the sheet 16 is located at the cutting position P2 (step S41: third conveying process).

After step S41, as depicted in FIG. 6B, the CPU 41 causes the cutting unit 24 to cut the sheet 16 (step S42: second cutting process). Accordingly, the first half part 16X and the second half part 16Y are separated from each other.

After step S42, as depicted in FIG. 6C, the CPU 41 causes the conveying unit 15 to convey the first half part 16X and the second half part 16Y in the first direction D1, so as to locate the first half part 16Y at the recording start position (step S43). In this situation, the second half part 16Y is located at the recording position P1.

After step S43, as depicted in FIG. 6D, the CPU 41 causes the recording unit 21 to record the image B on the second half part 16Y (step S44: third recording process). Also in step S44, the scanning process and the conveying process are alternately performed like step S32. FIG. 6D depicts that a partial image B1, which is a part of the image B, is recorded on the second half part 16Y. In accordance with the completion of the recording of the image B in step S44, the first sheet piece 161 being the first half part 16X on which no image is recorded and the second sheet piece 162 being the second half part 16Y on which the image B is recorded are generated.

After step S44, the first sheet piece 161 and the second sheet piece 162 are conveyed in the first direction D1 by the conveying unit 15, and the first sheet piece 161 and the second sheet piece 162 are received by the sheet discharge tray 13 (see FIG. 2).

As described above, according to the present embodiment, the cutting position P2 is located upstream of the recording unit 21 in the conveyance route R (see FIG. 2). In this configuration, the CPU 41 can execute the first control (step S3) in order to generate the first sheet piece 161 being the first half part 16X on which the image A is recorded and the second sheet piece 162 being the second half part 16Y on which the image B is recorded. In the first control (step S3), the cutting process (step S34: see FIG. 5C) is performed after the recording of at least a part of the image A (partial image A1) (step S32: see FIG. 5A) and before the recording of the image B (step S37). Accordingly, even if the distance from the recording unit 21 to cutting position P2 is decreased, the conveyance distance of the sheet 16 for cutting the sheet 16 is less likely to increase, and efficiency in image recording is less likely to decrease. Thus, the increase in the size of the printer 1 can be reduced suitably.

As depicted in FIG. 5E, in the first control (step S3), the CPU 41 causes the recording unit 21 to record the partial image A2, which is the remaining part of the image A, on the first half part 16X (step S36: third recording process) before causing the recording unit 21 to record the image B (step S37) and after the cutting process (step S34: see FIG. 5C). In this case, the remaining part of the image A can be recorded after the cutting, if necessary.

The distance X2 by which the sheet 16 is conveyed in step S33 is smaller than the distance X1 by which the sheet 16 is intermittently conveyed in step S32 (see FIG. 5A and FIG. 5B). In this case, the cutting planned position Q can be appropriately located at the cutting position P2, as compared with a case where the sheet 16 is conveyed in step S33 by the same distance as the distance X1 by which the sheet 16 is conveyed intermittently.

As depicted in FIG. 5D, the CPU 41 causes the conveyor 15 to convey the first half part 16X and the second half part 16Y by the distance X3 which is smaller than the distance X1 (step S35: third conveying process), after the cutting process (step S34) and before the third recording process (step S36). In this case, there is a high possibility that the process does not need to change the image data to be used in step S36, as compared with a case where the conveyance distance in step S35 is the distance X1, thereby reducing the load exerted on the CPU 41.

The CPU 41 can execute the second control (step S4), which is different from the first control (step S3), in order to generate the first sheet piece 161 being the first half part 16X on which no image is recorded and the second sheet piece 162 being the second half part 16Y on which the image B is recorded. In the second control (step S4), the image B is recorded (step S44: see FIG. 6C) after the cutting process (step S42: see FIG. 6B). Accordingly, the deterioration of the quality of the image can be reduced, which would be otherwise caused in a case where the cutting process is performed during the recording of the image B.

The distance from the recording unit 21 to the cutting position P2 in the conveyance route R is smaller than the half of the length along the conveyance route R of the sheet 16 of which length along the conveyance route R is the greatest among the sheets 16 having the plurality of sizes which can be accommodated in the sheet feed tray 11. In this case, the printer 1 can be made further small-sized.

The distance from the recording unit 21 to the cutting position P2 in the conveyance route R is 182 mm or less. In this case, the printer 1 can be made small-sized in a more ensured manner.

Next, a second embodiment of the present disclosure will be described.

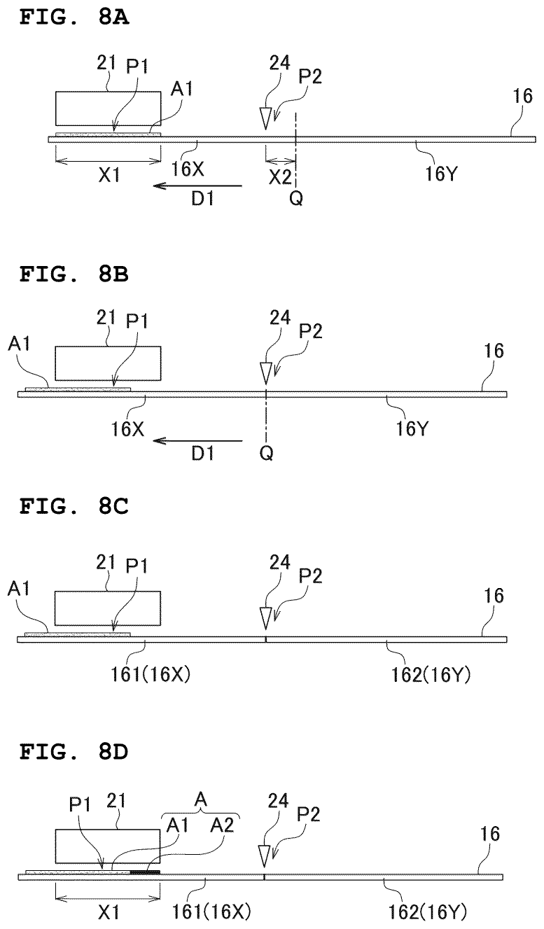

In the first embodiment, as depicted in FIG. 5D, the CPU 41 conveys the first half part 16X and the second half part 16Y by the distance X3 which is smaller than the distance X1 (step S35: third conveying process), after step S34 and before step S36. In contrast, in the second embodiment, the CPU 41 does not execute step S35, after step S34 and before step S36. In step S36, the CPU 41 starts the recording of the remaining part of the image A in a state that the first half part 16X and the second half part 16Y stand still at the positions at which the first half part 16X and the second half part 16Y has been located, respective, during step S34 (first cutting process: see FIG. 8C). In this procedure, among the plurality of nozzles of the recording unit 21, only the nozzles on the upstream side in the first direction D1 are used.

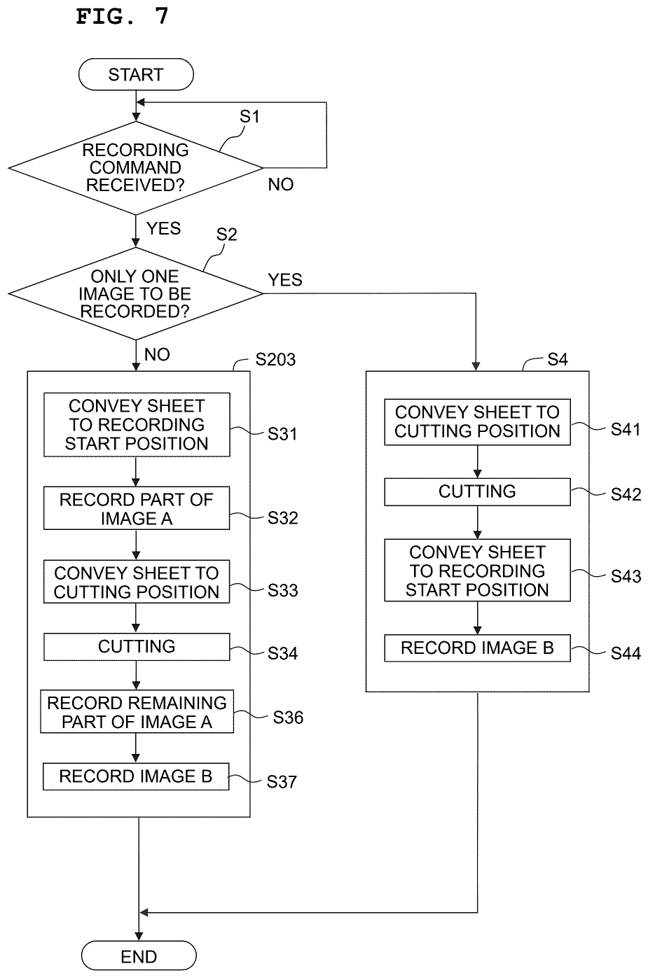

The first control of the second embodiment (step S203: see FIG. 7) is same as or similar to the first control of the first embodiment (Step S3: see FIG. 4), except that step S35 is not included.

According to the second embodiment, since the process of step S35 is not executed, the time required to perform the conveying process of step S35 is omitted, and thus the recording speed is improved.

Next, a third embodiment of the present disclosure will be described.

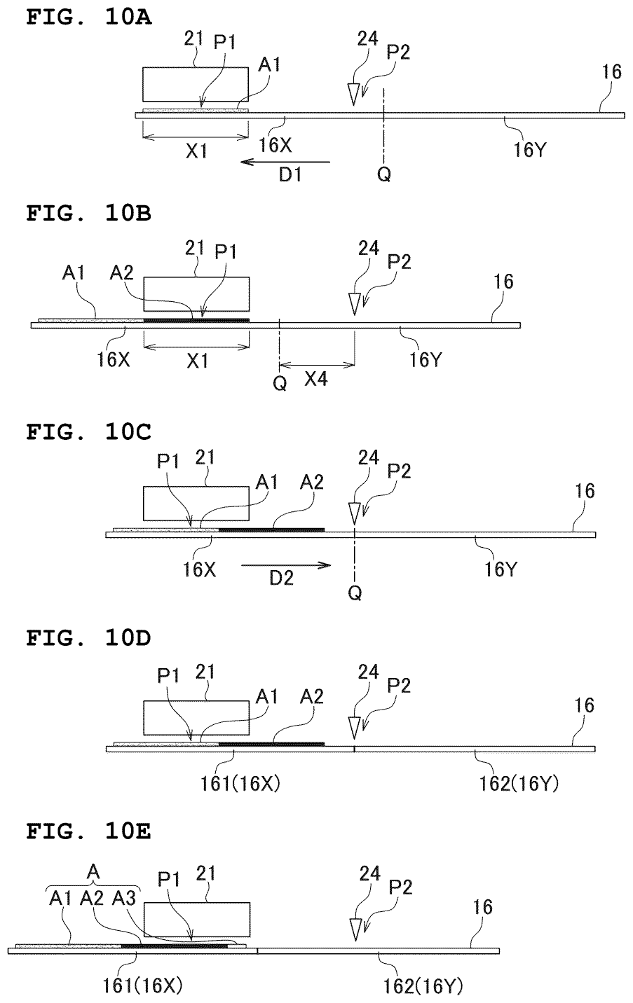

In the first embodiment, in step S33, the CPU 41 causes the conveying unit 15 to convey the sheet 16 in the first direction D1 (see FIG. 5B). In contrast, in the third embodiment, the CPU 41 causes the conveying unit 15 to convey the sheet 16 in a second direction D2 (the CPU 41 causes the conveying unit 15 to convey the sheet 16 in the opposite direction) in step S33 (see FIG. 10C). The second direction D2 is the direction which is opposite to the first direction D1. The second direction D2 is the direction from downstream to upstream of the conveyance route R (that is, rearward direction).

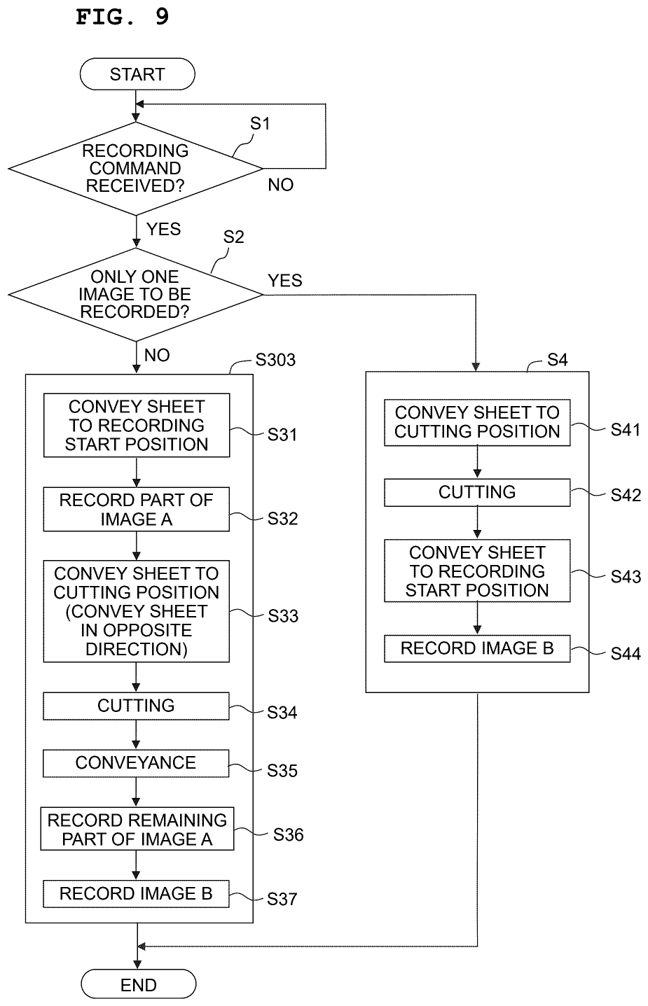

The first control of the third embodiment (step S303: see FIG. 9) is same as or similar to the first control of the first embodiment (step S3: see FIG. 4), except for the conveyance direction of the sheet 16 in step S33 and the conveyance distance of the sheet 16 in step S35.

In the third embodiment, the CPU 41 executes, in step S32, the recording of the partial image A1 by a first scanning process depicted in FIG. 10A and the recording of the partial image A2 by a second scanning process depicted in FIG. 10B. As depicted in FIG. 10B, the cutting planned position Q is located downstream of the cutting position P2 in the first direction D1 by a distance X4, at the point in time of the completion of step S32 (first recording process). Accordingly, in step S33, the CPU 41 causes the conveying unit 15 to convey the sheet 16 in the second direction D2 by the distance X4. The distance X4 is another example of the “second distance”. The distance X4 is smaller than the distance X1.

In the third embodiment, the CPU 41 causes the conveying unit 15 to convey the sheet 16 in the first direction D1 by the distance X1. Then, as depicted in FIG. 10E, in step S36, the CPU 41 causes the recording unit 21 to record the partial image A3 which is the remaining part of the image A on the first half part 16X. In this procedure, among the plurality of nozzles of the recording unit 21, only the nozzles on the upstream side in the first direction D1 are used.

According to the third embodiment, the distance X4 by which the sheet 16 is conveyed in step S33 is smaller than the distance X1 by which the sheet 16 is intermittently conveyed in step S32 (see FIG. 10B and FIG. 10C). In this case, the cutting planned position Q can be appropriately located at the cutting position P2, as compared with a case where the sheet 16 is conveyed in step S33 by the same distance as the distance X1 by which the sheet 16 is intermittently conveyed.

Next, a fourth embodiment of the present disclosure will be described.

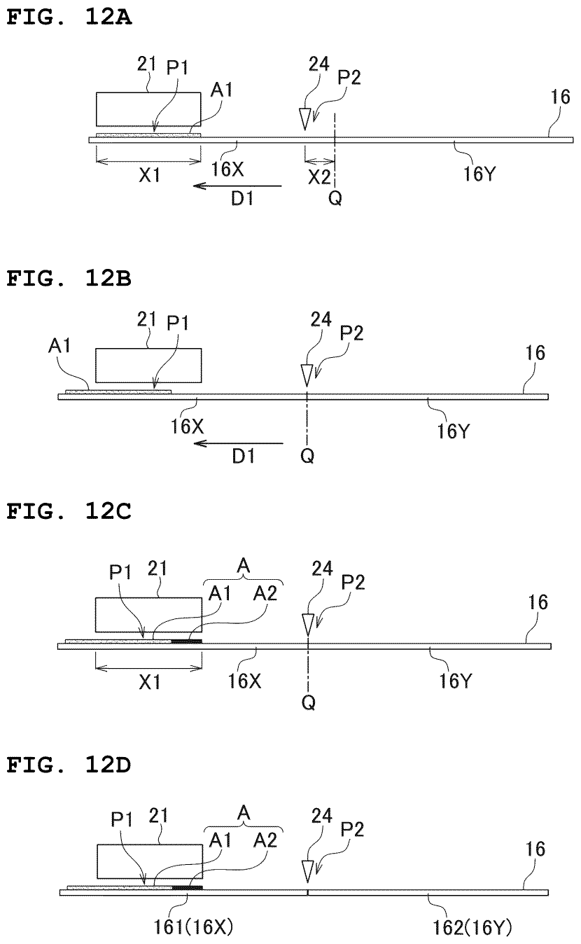

In the first embodiment, the CPU 41 causes the recording unit 21 to record the partial image A2 which is the remaining part of the image A (step S36: see FIG. 5E), after the cutting process (step S34: see FIG. 5C). In contrast, in the fourth embodiment, as depicted in FIG. 12C, the CPU 41 causes the recording unit 21 to record the partial image A2, which is the remaining part of the image A, on the first half part 16X (step S36: third recording process), after causing the conveying unit 15 to convey the sheet 16 so that the cutting planned position Q is located at the cutting position P2 (step S33: see FIG. 12B) and before the cutting process (step S34: see FIG. 12D).

Further, in the fourth embodiment, step S35 is not executed like the second embodiment. In step S36, the recording of the remaining part of the image A is started in a state that the first half part 16X and the second half part 16Y stand still at the positions at which the first half part 16X and the second half part 16Y have been located during step S34, respectively. In this situation, among the plurality of nozzles of the recording unit 21, only the nozzles on the upstream side in the first direction D1 are used.

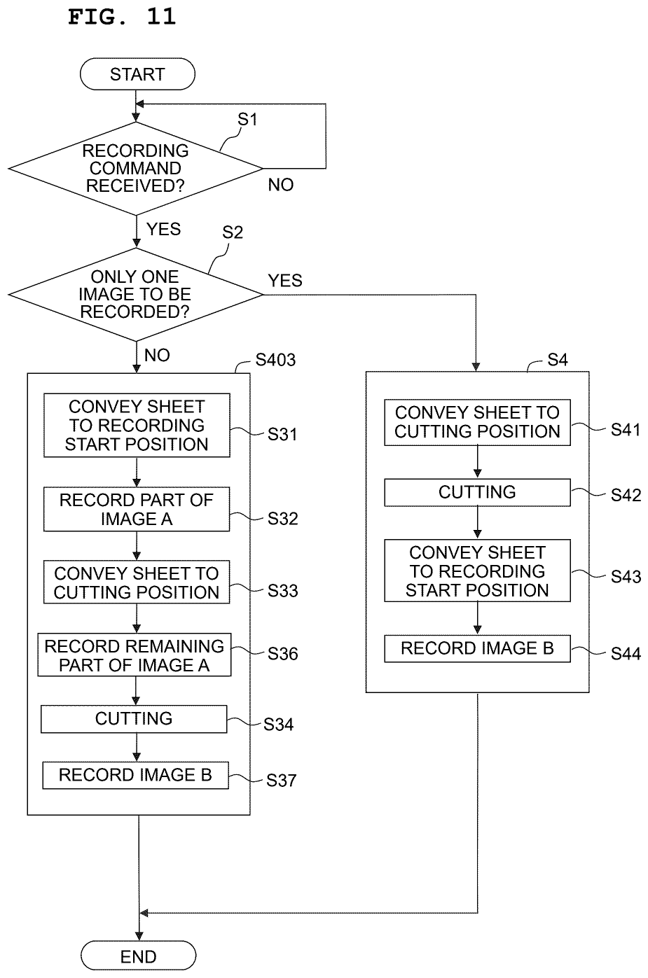

The first control of the fourth embodiment (step S403: see FIG. 11) is same as or similar to the first control of the first embodiment (step S3: see FIG. 4), except that step S35 is not included and that step S36 is executed before step S34.

According to the fourth embodiment, the recording of the remaining part of the image A is performed before the cutting. In this case, the deterioration of the image quality can be reduced, which would be otherwise caused by the positional deviation of the sheet 16 during the cutting, as compared with a case in which the recording of the remaining part of the image A is performed after the cutting as in the first embodiment.

Further, also in the fourth embodiment, like the first embodiment, the distance X2 by which the sheet 16 is conveyed in step S33 is smaller than the distance X1 by which the sheet 16 is intermittently conveyed in step S32 (see FIG. 12A and FIG. 12B). In this case, the cutting planned position Q can be appropriately located at the cutting position P2, as compared with a case in which the sheet 16 is conveyed in step S33 by the same distance as the distance X1 by which the sheet 16 is intermittently conveyed.

Next, a fifth embodiment of the present disclosure will be described.

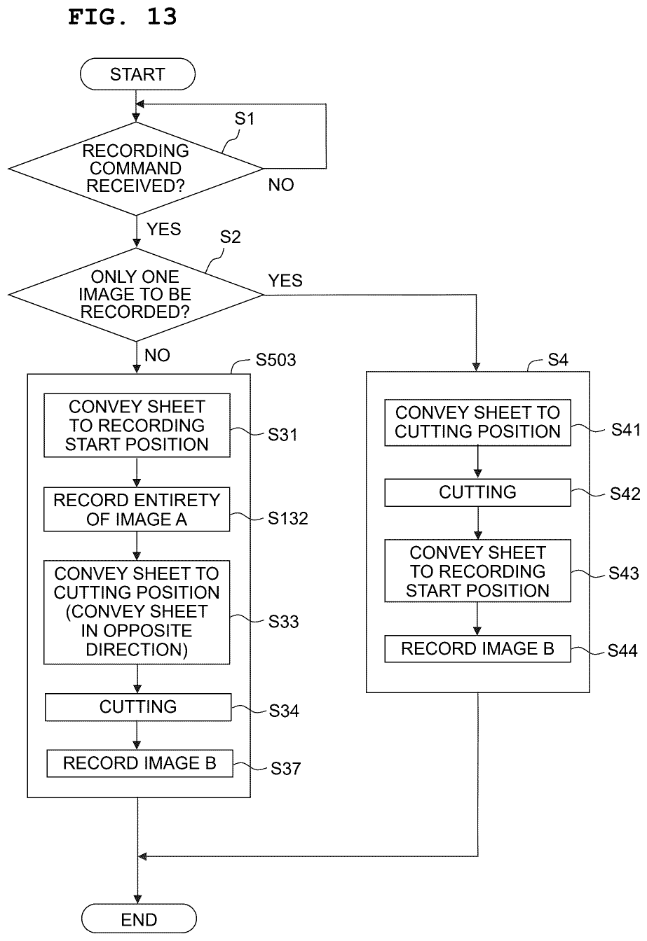

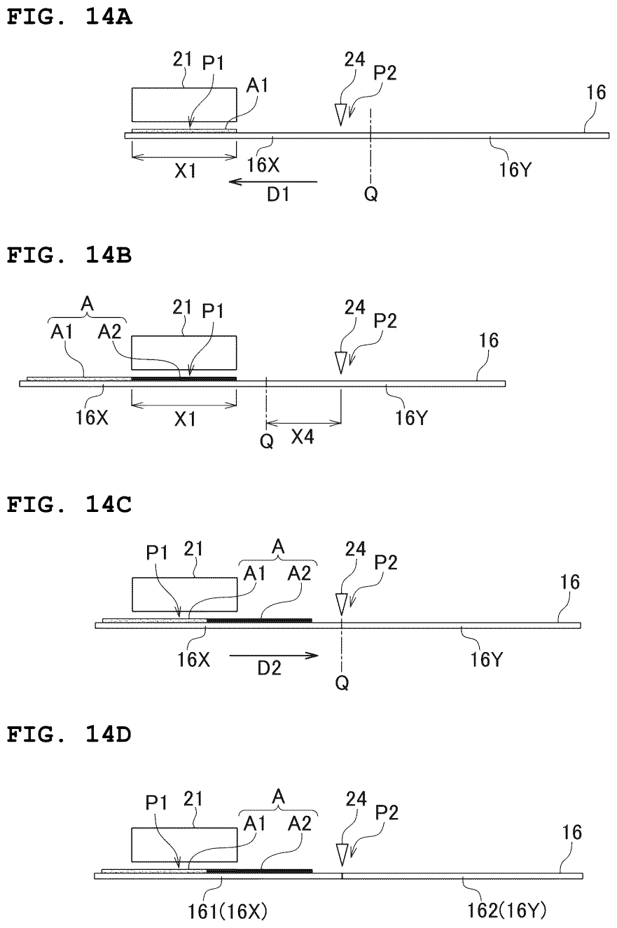

In the first embodiment (see FIG. 4), the CPU 41 causes the recording unit 21 to record the part of the image A (step S32), after step S31 and before step S33. In contrast, in the fifth embodiment (see FIG. 13), the CPU 41 causes the recording unit 21 to record the entirety of the image A (step S132) after step S31 and before step S33. Further, in the fifth embodiment, as depicted in FIG. 14C, the CPU 41 causes the conveying unit 15 to convey the sheet 16 in the second direction D2 (the CPU 41 causes the conveying unit 15 to convey the sheet 16 in the opposite direction) in step S33.

The first control of the fifth embodiment (step S503: see FIG. 13) is same as or similar to the first control of the first embodiment (step S3: see FIG. 4), except that step S132 is executed instead of step S32 after step S31 and before step S33 and that the sheet 16 is conveyed in step S33 in the second direction D2 which is different from the direction D1 in the first control of the first embodiment.

In the fifth embodiment, the CPU 41 executes, in step S132, the recording of the partial image A1 by a first scanning process depicted in FIG. 14A and the recording of the partial image A2 by a second scanning process depicted in FIG. 14B. As depicted in FIG. 14B, at the point in time at which step S132 (first recording process) is completed, the cutting planned position Q is located downstream of the cutting position P2 in the first direction D1, by the distance X4. On this account, in step S33, the CPU 41 causes the conveying unit 15 to convey the sheet 16 in the second direction D2 by the distance X4. The distance X4 is smaller than the distance X1.

According to the fifth embodiment, the entirety of the image A is recorded before the cutting. The deterioration of the image quality, which would be otherwise caused by the positional deviation of the sheet 16 during the cutting, can be reduced, as compared with a case where the remaining part of the image A is recorded after the cutting as in the first embodiment.

Further, according to the fifth embodiment, the distance X4, by which the sheet 16 is conveyed in step S33, is smaller than the distance X1 by which the sheet 16 is intermittently conveyed in step S32 (see FIG. 14B and FIG. 14C). In this case, the cutting planned position Q can be appropriately located at the cutting position P2, as compared with a case where the sheet 16 is conveyed in step S33 by the same distance as the distance X1 by which the sheet 16 is intermittently conveyed.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the recording medium is not limited to the sheet (that is, a paper sheet), and may be cloth, a resin member, etc.

The recording unit is not limited to the recording unit of the ink-jet system, and may also be a recording unit of the laser system, the thermal transfer system, etc.

The present disclosure is not limited to being applicable to the printer, and may applicable also to a facsimile, a copy machine, a multi-function periphery, etc.

The program according to the present disclosure can be distributed while being stored on a removable type recording medium such as a flexible disk, etc., or a fixed type storage medium such as a hard disk, etc. Further, the program according to the present disclosure can be distributed via a communication line.

What is claimed is:

1. A recording apparatus comprising:
a recorder configured to record an image on a recording medium;
a cutter configured to cut the recording medium at a cutting position so as to divide the recording medium into a first medium and a second medium;
a conveyor configured to convey the recording medium toward the recorder along a conveyance route; and
a controller, wherein:
the cutting position is located upstream of the recorder in the conveyance route;
the controller is configured to execute first control so as to generate a first recorded item being the first medium on which a first image is recorded and a second recorded item being the second medium on which a second image is recorded; and
the first control includes:
a first conveying process of causing the conveyor to convey a first objective recording medium to a recording start position, the first objective recording medium being the recording medium which is single and which is an object of the first control;
a first recording process of causing the recorder to record at least a part of the first image on the first objective recording medium after the first conveying process;
a second conveying process of causing the conveyor to convey the first objective recording medium so that a cutting planned position of the first objective recording medium is located at the cutting position after the first recording process;
a first cutting process of causing the cutter to cut the first objective recording medium after the second conveying process; and
a second recording process of causing the recorder to record the second image on the second medium obtained by cutting the first objective recording medium, after the first cutting process.

2. The recording apparatus according to claim 1, wherein:
the controller is configured to cause the recorder to record only the part of the first image on the first objective recording medium in the first recording process; and
the first control further includes a third recording process of causing the recorder to record a remaining part of the first image on the first medium obtained by cutting the first objective recording medium, after the first cutting process and before the second recording process.

3. The recording apparatus according to claim 2, wherein:
the first recording process includes:
a first process of causing the recorder to record a portion of the part of the first image on the first objective recording medium which stands still in the conveyance route;
a second process of causing the conveyor to convey the first objective recording medium by a first distance after the first process; and
a third process of causing the recorder to record another portion of the part of the first image on the first objective recording medium which stands still after having caused the conveyor to convey the first objective recording medium by the first distance in the second process; and
a second distance, by which the first objective recording medium is conveyed in the second conveying process, is smaller than the first distance.

4. The recording apparatus according to claim 3, wherein:
the first control further includes a third conveying process of causing the conveyor to convey the first medium obtained by cutting the first objective recording medium by a third distance after the first cutting process and before the third recording process; and
the third distance is smaller than the first distance.

5. The recording apparatus according to claim 3, wherein in the third recording process, the controller is configured to cause the recorder to start recording of the remaining part of the first image in a state that the first medium obtained by cutting the first objective recording medium stands still at a position at which the first medium obtained by cutting the first objective recording medium is located during the first cutting process.

6. The recording apparatus according to claim 2, wherein in the second conveying process, the controller is configured to cause the conveyor to convey the first objective recording medium from downstream toward upstream of the conveyance route.

7. The recording apparatus according to claim 6, wherein:
the first recording process includes:
a first process of causing the recorder to record a portion of the part of the first image on the first objective recording medium which stands still in the conveyance route;
a second process of causing the conveyor to convey the first objective recording medium by a first distance after the first process; and
a third process of causing the recorder to record another portion of the part of the first image on the first objective recording medium which stands still after having caused the conveyor to convey the first objective recording medium by the first distance in the second process; and
a second distance by which the first objective recording medium is conveyed in the second conveying process is smaller than the first distance.

8. The recording apparatus according to claim 1, wherein:
the controller is configured to cause the recorder to record only the part of the first image on the first objective recording medium in the first recording process; and
the first control further includes a third recording process of causing the recorder to record a remaining part of the first image on a part of the first objective recording medium corresponding to the first medium, after the second conveying process and before the first cutting process.

9. The recording apparatus according to claim 8, wherein:
the first recording process includes:
a first process of causing the recorder to record a portion of the part of the first image on the first objective recording medium which stands still in the conveyance route;
a second process of causing the conveyor to convey the first objective recording medium by a first distance after the first process; and
a third process of causing the recorder to record another portion of the part of the first image on the first objective recording medium which stands still after having caused the conveyor to convey the first objective recording medium by the first distance in the second process; and
a second distance, by which the first objective recording medium is conveyed in the second conveying process, is smaller than the first distance.

10. The recording apparatus according to claim 1, wherein the controller is configured to cause the recorder to record entirety of the first image on the first objective recording medium in first recording process.

11. The recording apparatus according to claim 1, wherein:
the controller is configured to execute second control, which is different from the first control, so as to generate the first medium on which no image is recorded and a third recorded item being the second medium on which a third image is recorded; and
the second control includes:
a third conveying process of causing the conveyor to convey a second objective recording medium so that the cutting planned position of the second objective recording medium is located at the cutting position, the second objective recording medium being the recording medium which is single and which is an object of the second control;
a second cutting process of causing the cutter to cut the second objective recording medium after the third conveying process; and
a third recording process of causing the recorder to record the third image on the second medium obtained by cutting the second objective recording medium, after the second cutting process.

12. The recording apparatus according to claim 1, further comprising a container which is configured to accommodate a plurality of the recording medium having mutually different lengths along the first conveyance route,
wherein a distance from the recorder to the cutting position in the first conveyance route is smaller than a half of a length of a recording medium having the length which is greatest among the plurality of the recording medium.

13. The recording apparatus according to claim 1, wherein a distance from the recorder to the cutting position in the first conveyance route is 182 mm or less.

14. A control method of a recording apparatus, the recording apparatus including:
a recorder configured to record an image on a recording medium;
a cutter configured to cut the recording medium at a cutting position so as to divide the recording medium into a first medium and a second medium; and
a conveyor configured to convey the recording medium toward the recorder along a conveyance route,
wherein the cutting position is located upstream of the recorder in the conveyance route,
the control method comprising executing first control so as to generate a first recorded item being the first medium on which a first image is recorded and a second recorded item being the second medium on which a second image is recorded,
wherein the first control includes:
a first conveying process of causing the conveyor to convey a first objective recording medium to a recording start position, the first objective recording medium being the recording medium which is single and which is an object of the first control;
a first recording process of causing the recorder to record at least a part of the first image on the first objective recording medium after the first conveying process;
a second conveying process of causing the conveyor to convey the first objective recording medium so that a cutting planned position of the first objective recording medium is located at the cutting position after the first recording process;
a first cutting process of causing the cutter to cut the first objective recording medium after the second conveying process; and
a second recording process of causing the recorder to record the second image on the second medium obtained by cutting the first objective recording medium, after the first cutting process.

15. A non-transitory and computer-readable medium storing a program executable by a controller of a recording apparatus, the recording apparatus including:
a recorder configured to record an image on a recording medium;
a cutter configured to cut the recording medium at a cutting position so as to divide the recording medium into a first medium and a second medium;
a conveyor configured to convey the recording medium toward the recorder along a conveyance route; and
the controller,
wherein the cutting position is located upstream of the recorder in the conveyance route,
the program is configured to cause the controller to execute first control so as to generate a first recorded item being the first medium on which a first image is recorded and a second recorded item being the second medium on which a second image is recorded,
wherein the first control includes:
a first conveying process of causing the conveyor to convey a first objective recording medium to a recording start position, the first objective recording medium being the recording medium which is single and which is an object of the first control;
a first recording process of causing the recorder to record at least a part of the first image on the first objective recording medium after the first conveying process;
a second conveying process of causing the conveyor to convey the first objective recording medium so that a cutting planned position of the first objective recording medium is located at the cutting position after the first recording process;
a first cutting process of causing the cutter to cut the first objective recording medium after the second conveying process; and
a second recording process of causing the recorder to record the second image on the second medium obtained by cutting the first objective recording medium, after the first cutting process.
